(19) United States
(12) Patent Application Publication
(10) Pub. No.: US 2003/0174426 A1
(43) Pub. Date: Sep. 18, 2003

(54) Method and apparatus for turbo coding and decoding in read and write channel of a disk drive

(75) Inventor: Manabu Akamatsu, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/342,190

(22) Filed: Jan. 15, 2003

(30) Foreign Application Priority Data
Mar. 13, 2002 (JP) 2002-069140

(51) Int. Cl. G11B 5/09

(52) U.S. Cl. 360/46

(57) ABSTRACT

There is disclosed a disk drive in which a read/write channel including a concatenated turbo codec is used. The turbo codec includes an RSC encoder using a code length M as a unit to code a sequence to an RSC sequence in a relation between an interleaver length N and code length M in which a relation equation “N=c·M, c>1” is established, and an APP decoder which executes APP decoding processing with respect to the RSC sequence.

### CROSS-REFERENCE TO RELATED APPLICATIONS

This application is based upon and claims the benefit of priority from the prior Japanese Patent Application No. 2002-069140, filed Mar. 13, 2002, the entire contents of which are incorporated herein by reference.

### BACKGROUND OF THE INVENTION

1. Field of the Invention

The present invention generally relates to the field of disk drives, particularly to a data recording/reproducing technique to which a turbo coding/decoding method is applied. 2. Description of the Related Art

In general, in a disk drive represented by a hard disk drive, a read/write channel is disposed to execute signal processing of a read signal (reproduction data signal) read out from a disk as a recording medium by a head or a write signal (recording data signal) recorded on the disk.

In the read/write channel, usually a so-called partial response maximum likelihood (PRML) method has been used which is constituted by combining a partial response (PR) method and Viterbi decoding method.

Additionally, in recent years, in the field of disk drives, a turbo coding/decoding method has been proposed which is expected to provide characteristics more satisfactory than those of the PRML method. Examples of prior-art documents include “CODING AND ITERATIVE DETECTION FOR MAGNETIC RECORDING CHANNELS by Zining Wu (Kluwer Academic Publishers)”.

For the read/write channel of the disk drive, a concatenated turbo coding/decoding method has been studied. In a turbo codec using this method, a recursive systematic convolutional (RSC) code is used to generate a systematic code sequence including information and parity sequences. The information sequence means a recording data sequence (input information sequence) in the disk drive. Moreover, the parity sequence indicates an error correction bit string (check bit string).

On the other hand, in a decoding system, an APP decoder is used which executes a posteriori probability (APP) decoding by soft-output Viterbi algorithm (SOVA) for obtaining a soft output decode based on a Viterbi algorithm.

A concatenated turbo codec applied to the read/write channel includes an RSC encoder, and generates a systematic code sequence including the information and parity sequences. Additionally, in general, when a code length of the code sequence (error correction code) increases, error correction capability is enhanced, and, as a result, a satisfactory error correction rate (improvement amount) can be realized.

However, when the code length is simply increased, the constitution of the decoder in the decoding system becomes complicated. In the turbo codec, the above-described APP decoder is used. Therefore, with an increase of the code length of RSC, there accordingly occurs a problem that the constitution of the APP decoder is complicated or that circuit scale is enlarged.

### BRIEF SUMMARY OF THE INVENTION

In accordance with one embodiment of the present invention, there is provided a concatenated turbo codec which realizes a predetermined error correction rate without increasing an actual code length particularly with respect to a disk drive in which a read/write channel including the concatenated turbo codec is used.

The present disk drive comprises: a head for performing read/write of data with respect to a disk medium; and a read/write channel including a coding/decoding unit of a concatenated turbo coding/decoding system, which is a signal processing circuit of a recording data signal or reproduction data signal to be transmitted with respect to the head, wherein the coding/decoding unit includes:

a unit which executes interleaving in a predetermined interleaver length with respect to a recording data sequence at a data recording time; and

an RSC encoder which uses a code length having a predetermined relation with respect to the interleaver length as a unit to code the recording data sequence interleaved by the unit into a recursive systematic coded sequence.

### BRIEF DESCRIPTION OF THE SEVERAL VIEWS OF THE DRAWING

FIG. 1 is a block diagram showing a main part of a disk drive according to an embodiment of the present invention;

FIGS. 2A and 2B are block diagrams showing a main part of a turbo codec according to the embodiment;

FIG. 3 is a block diagram showing an RSC encoder according to the embodiment; and

FIG. 4 is a diagram showing a relation between an interleaver length and code length according to the embodiment.

### DETAILED DESCRIPTION OF THE INVENTION

Embodiments of the present invention will be described hereinafter with reference to the drawings.

(Constitution of Disk Drive)

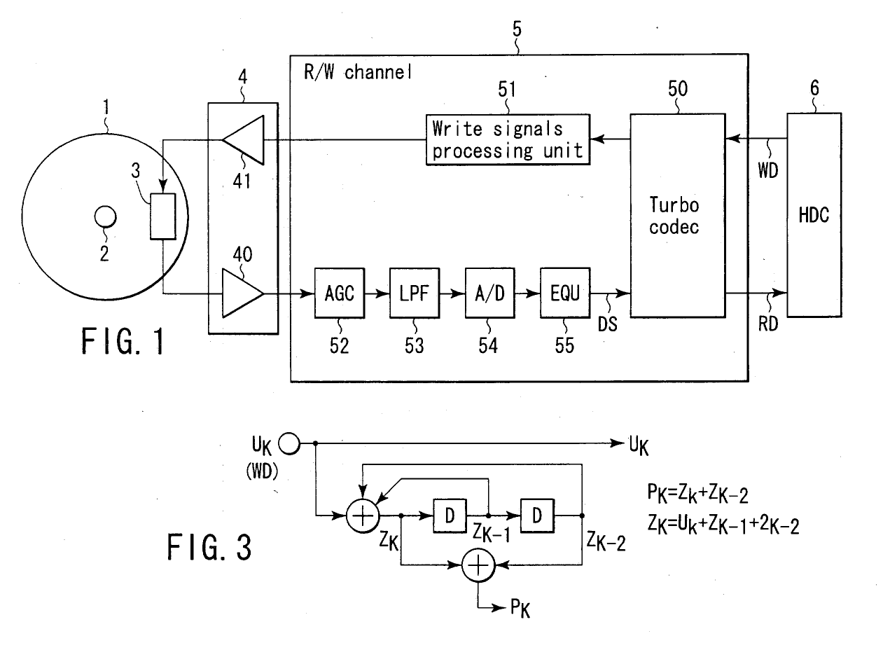

FIG. 1 is a block diagram showing a main part of a disk drive according to an embodiment of the present invention.

The present disk drive includes a disk 1 as a data recording medium, preamplifier circuit 4, read/write channel 5, and disk controller (HDC) 6.

The disk 1 is rotated by a spindle motor (SPM) 2. A head 3 includes read and write heads, and reads out data from the disk 1 by the read head. Moreover, the head 3 writes data onto the disk 1 by the write head. The preamplifier circuit 4 includes a read amplifier 40 which amplifies a read signal (reproduction data signal) from the read head and sends the signal to the read/write channel 5. The preamplifier circuit 4 also includes a write amplifier 41 which converts a write signal (recording data signal) output from the read/write channel 5 into a write current and supplies the current to the write head.

The read/write channel 5 includes a turbo codec 50 to which a concatenated turbo coding/decoding system is applied. A write channel includes a turbo encoder and write signal processing unit 51. The write signal processing unit 51 includes a write pre-compensator, and the like.

A read channel includes a turbo decoder, auto gain control (AGC) amplifier circuit 52, low pass filter (LPF) 53, A/D converter 54, and equalizer 55.

The AGC amplifier circuit 52 controls the read signal output from the read amplifier 40 so that a signal amplitude of the signal has a given value. The LPF 53 removes high-frequency noise from the read signal. The A/D converter 54 converts the analog read signal to a digital signal. The equalizer 55 usually includes a digital filter of a finite impulse response (FIR) system, and executes digital waveform equalization processing.

Here, in the read/write channel 5, a PR channel includes an input of the write amplifier 41 to an output of the equalizer 55 in digital magnetic recording/reproducing, and has desired partial response (PR) characteristics. Coded data in the PR channel is regarded as one type of convolutional code, and corresponds to an inner code in a concatenated turbo code.

(Constitution of Turbo Codec)

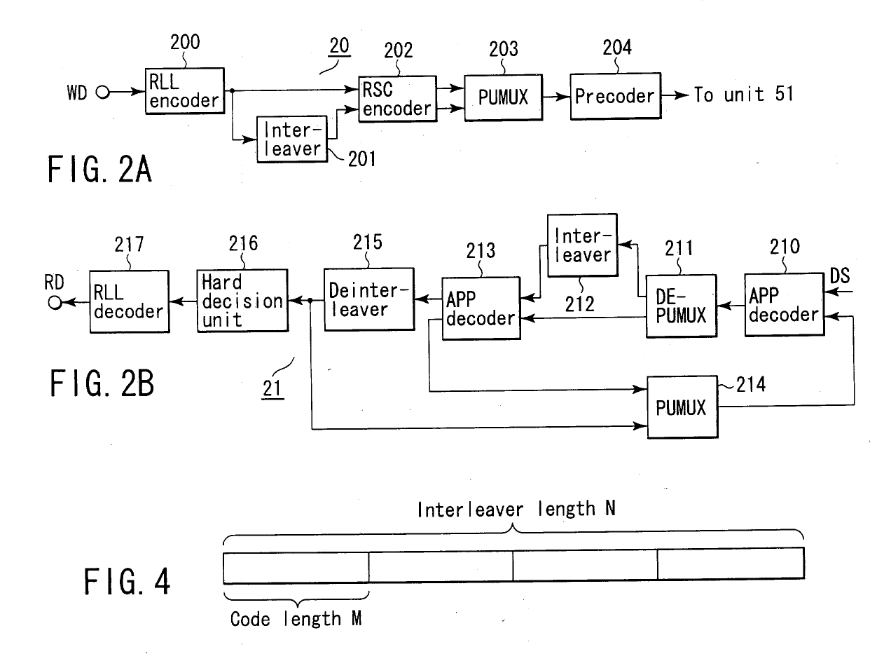

The turbo codec 50 is constituted of a turbo encoder 20 shown in FIG. 2A, and turbo decoder 21 shown in FIG. 2B. The turbo encoder 20 includes a run length limited (RLL) encoder 200, interleaver 201, recursive systematic convolutional (RSC) coded sequence encoder 202, PUMUX 203, and precoder 204.

The RLL encoder 200 converts recording data WD into a usual RLL code sequence. The interleaver 201 executes interleaving corresponding to agitation processing (randomization) of the RLL code sequence. The RSC encoder 202 executes recursive systematic convolutional coding processing as an outer code with respect to the RLL code sequence. The PUMUX 203 is a puncture multiplexing circuit constituted by combining a puncture circuit and multiplexer, and outputs a systematic code sequence obtained by multiplexing information and parity sequences. The precoder 204 is disposed to impart recursive characteristics to the PR channel.

On the other hand, the turbo decoder 21 includes an APP decoder 210 which performs a posteriori probability (APP) decoding processing with respect to a PR channel (inner code), DE-PUMUX 211, interleaver 212, APP decoder 213 which executes the APP decoding processing with respect to an RSC sequence (outer code), PUMUX 214 for use at a repeated decoding processing time, and deinterleaver 215.

The DE-PUMUX 211 is a circuit constituted by combining a depuncture circuit with a demultiplexer, and executes inverse transform processing of the PUMUX 203. Moreover, the deinterleaver 215 executes the inverse transform processing of the interleaver 212.

Furthermore, the turbo decoder 21 includes a hard decision unit 216 and RLL decoder 217. The hard decision unit 216 uses a log likelihood ratio (LLR) outputted from the APP decoder 213 as a threshold value to execute binary decision, and determines a final turbo decoded sequence. The RLL decoder 217 subjects the turbo coded sequence to RLL decoding processing, and outputs the reproduction data sequence (RD) corresponding to the original user data. Here, the APP decoder 213 outputs outer information of outer codes excluding LLR to the PUMUX 214.

Note that the turbo codec 50 shown in FIGS. 2A and 2B is realized, for example, by a constitution including software and CPU which executes the software. In this case, here, FIGS. 2A and 2B show the software for realizing the function of the turbo codec 50, and the software corresponds to a processing procedure of a CPU.

(Operation of Turbo Codec)

An operation of the turbo codec 50 of the embodiment will be described next.

At the data recording time, as shown in FIG. 1, the HDC 6 sends the recording data WD (information sequence) received from a host system (e.g., personal computer, and the like) to the read/write channel 5. In the read/write channel 5, the turbo encoder 20 executes turbo coding processing, and sends an output to the write amplifier 41 via the write signal processing unit 51.

In the turbo encoder 20, the RSC encoder 202 subjects the RLL code sequence of the recording data WD to RSC coding processing. Here, for example, as shown in FIG. 3, the RSC encoder 202 is constituted of: a delay element (D) of one bit; and a mod2 adder (exclusive OR gate (+)).

FIG. 3 shows a concrete example of the RSC encoder 202 with a constraint length of 3. An input information sequence (Uₖ) is the RLL code sequence output from the RLL encoder 200. Moreover, a parity sequence (Pk) generated by the RSC encoder 202 is expressed as an inner sequence (Zk).

The interleaver 201 subjects the RLL code sequence to interleave processing, and gives the sequence to the RSC encoder 202. The RSC encoder 202 inputs the RLL code sequence output from the RLL encoder 200 together with the RLL code sequence subjected to the interleave processing (agitation processing) with an interleaver length N by the interleaver 201.

The RSC encoder 202 generates a recursive systematic convolutional (RSC) code sequence including the information and parity sequences in accordance with a constraint length K and redundant bits J shown in the following equation (1).

K=L_{RSC}

J=L_{RSC}−1

As shown in FIG. 4, the RSC encoder 202 uses a code length M as a unit to convert the RLL code sequence as an information bit string corresponding to the interleaver length N to an RSC sequence. That is, the RSC encoder 202 executes processing of inserting redundant J bits in accordance with the constraint length K.

The PUMUX 203 executes processing of taking out one bit from the parity sequence outputted from the RSC encoder 202 every m bits and inserting the bit into the information sequence from the RSC encoder 202. Therefore, a coding rate (puncture rate) is “m/(m+1)”.

Subsequently, the precoder 204 executes processing of inserting the redundant bits J in accordance with the constraint length K and redundant bits J shown in the following equation (2) in order to generate the sequence in each code length Mi.

$$\begin{matrix}K = {L}_{PR} \\ J = {L}_{PR} - 1\end{matrix} \} \qquad ( 2 )$$

Here, there is a relation shown in the following equation (3) between the code length M of the outer code and the code length Mi of the inner code.

$$M i = b \cdot ⌊ \frac{m + 1}{m} \cdot ( M + {L}_{RSC} - 1 ) ⌋ , ( b > 0 ) \qquad ( 3 )$$

where b>0.

The precoder 204 subjects the systematic coded sequence from the PUMUX 203 to a type of inverse transform processing as described above, and thereafter sends the sequence to the write signal processing unit 51. The write signal processing unit 51 executes recording compensation processing, and sends the systematic coded sequence to the write amplifier 41. Therefore, the write head uses a write current supplied from the write amplifier 41 to record a turbo coded recording data signal onto the disk 1.

Subsequently, the reproduction data signal (DS) read out from the disk 1 by the read head is amplified by the read amplifier 40, and sent to the read/write channel 5. The reproduction data signal is sent to the turbo decoder 21 via a signal processing system in the read channel.

In the turbo decoder 21, the APP decoder 210 inputs a signal output from an FIR type digital filter of the equalizer 55, and an advance log likelihood ratio. The APP decoder 210 uses a code length Mu1 as a unit as shown in the following equation (4) as a unit to execute a posteriori probability (APP) decoding processing, and outputs an outer log likelihood ratio.

$$\begin{matrix}Mu 1 = Mi + {L}_{PR} - 1 \\ Mu 2 = M + {L}_{RSC} - 1\end{matrix} \} \qquad ( 4 )$$

The outer log likelihood ratio is divided into the advance log likelihood ratio, for the information sequence, and the advance log likelihood ratio, for the parity sequence, by the DE-PUMUX 211 which executes the inverse transform of the PUMUX 203 of the turbo encoder 20. The advance log likelihood ratio for the information sequence is subjected to interleave processing (agitated) by the interleaver 212 which has the same function as that of the interleaver 201, and is inputted together with the advance log likelihood ratio for the parity sequence into the APP decoder 213.

The APP decoder 213 uses a code length Mu2 shown in the above equation (4) as a unit to execute the a posteriori probability (APP) decoding processing, and outputs the outer log likelihood ratios for the information and parity sequences. The outer log likelihood ratio for the information sequence is returned to the original sequence by the deinterleaver 215 which executes the transform inverse to that of the interleaver 201, and thereafter inputted together with the outer log likelihood ratio for the parity sequence into the PUMUX 214.

The PUMUX 214 executes the same transform processing as that of the PUMUX 203 of the turbo encoder 20, and inputs the advance log likelihood ratio to a precoded PR channel as the inner code into the APP decoder 210. Moreover, an output sequence of the deinterleaver 215 is inputted into the hard decision unit 216 which uses “0” as the threshold value. The hard decision unit 216 outputs a binary decision result to the RLL decoder 217. The RLL decoder 217 executes RLL decoding processing, and outputs the reproduction data sequence (RD) corresponding to the original user data.

As described above, in the read/write channel 5 of the embodiment, turbo coding/decoding processing is executed. In general, in the coding/decoding, when the code length increases, error correction capability is enhanced, and, as a result, a satisfactory error correction rate (improvement amount) can be realized. However, when the code length is simply increased, a circuit constitution including the APP decoders 210, 213 in the turbo decoder 21 is complicated, and circuit scale is enlarged.

Therefore, in the method of the present embodiment, as shown in FIG. 4, the code length M of the outer code is set to be relatively small with respect to the interleaver length N, and the code length M is used as the unit to execute the coding/decoding processing. In a turbo coding/decoding method, since the outer code is connected to the inner code via the interleaver, and the coding/decoding is executed, an apparent code length is not reduced. Here, a relation between the interleaver length N and the code length M of the outer code can be represented by the following equation (5).

N=c·M, where c>1 (5)

That is, when c is enlarged, and even when the code length M is relatively reduced, the apparent code length of the whole coded sequence is not reduced.

Moreover, similarly, it is also possible to relatively reduce the code length Mi of the inner code. When b in the above equation (3) is set to “1”, a relation between the interleaver length N and code length Mi of the inner code is represented by the following equation (6).

$$N = c \cdot ( \frac{m}{m + 1} Mi - {L}_{RSC} - 1 ) \qquad ( 6 )$$

In short, with the turbo codec of the embodiment, even when the respective code lengths M, Mi of the outer and inner codes are relatively reduced, the apparent code length of the whole coded sequence cannot be reduced. Therefore, since the apparent code length is relatively large, the satisfactory error correction rate (improvement amount) can be secured. Moreover, since the actual code length can be relatively reduced, the circuit constitution including the APP decoders 210, 213 in the turbo decoder 21 is relatively simplified, and the circuit scale can be prevented from being enlarged.

According to the present embodiment, as described above in detail, when the read/write channel using the concatenated turbo codec is realized in the disk drive, the satisfactory error correction rate (improvement amount) can be secured, further the circuit constitution including the APP decoder for use in a decoding system is simplified, and the circuit scale can be prevented from being enlarged.

Concretely, according to the present embodiment, when a turbo code sequence is constituted as an information bit number including a size (N) of interleaver length, the apparent code length can be increased with respect to the actual code length M (N=cM, c>1). Therefore, a predetermined error correction rate can be secured. On the other hand, the actual code length M is reduced, and the constitution of the APP decoder can be made simpler, and an enlarged circuit scale can thereby be avoided. Thereby, the coding/decoding circuit included in the read/write channel of the disk drive can be simplified.

What is claimed is:

1. A disk drive comprising:
a head which performs read/write of data with respect to a disk medium; and
a read/write channel including a signal processing unit which processes a recording data signal or reproduction data signal to be transmitted with respect to the head and a turbo codec which executes concatenated turbo coding/decoding, wherein the turbo codec includes:
an interleaver unit which executes interleaving in a predetermined interleaver length with respect to a recording data sequence at a data recording time; and
an RSC encoder which uses a code length having a predetermined relation with respect to the interleaver length as a unit to code the recording data sequence interleaved by the interleave unit into a recursive systematic coded sequence.

2. The disk drive according to claim 1, wherein the turbo codec comprises an APP decoder which executes decoding processing in an a posteriori probability method with respect to the recursive systematic coded sequence at a data reproduction time.

3. The disk drive according to claim 1, wherein the turbo codec is constituted to satisfy a relation equation “N=c·M, where c>1” between the interleaver length N and code length M.

4. The disk drive according to claim 1, wherein the turbo codec comprises an RLL encoder which converts the recording data sequence to a run length limited code (RLL), and
the interleaver unit is constituted to execute the interleaving in the predetermined interleaver length with respect to an RLL sequence output from the RLL encoder.

5. The disk drive according to claim 1, wherein the RSC encoder uses a predetermined code length as a unit to code the RLL sequence interleaved by the interleaver unit to a recursive systematic coded sequence to which predetermined redundant bits are added.

6. The disk drive according to claim 1, wherein the turbo codec comprises:
a puncture unit which executes thinning processing in a thinning rate to secure a predetermined error rate with respect to the recursive systematic coded sequence outputted from the RSC encoder; and
a precoder which imparts recursive characteristics to the coded sequence outputted from the puncture unit.

7. The disk drive according to claim 6, wherein the precoder is constituted to impart the recursive characteristics to the coded sequence output from the puncture unit, and to execute processing of adding predetermined redundant bits in order to transit to a certain specific state using a predetermined code length as a unit.

8. A concatenated turbo coding/decoding method applied to a read/write channel included in a disk drive which performs recording/reproducing of data with respect to a disk medium, comprising:
executing interleaving in a predetermined interleaver length with respect to a recording data sequence at a data recording time;
executing RSC coding to code the interleaved recording data sequence to a recursive systematic convolutional coded sequence using a predetermined code length as a unit; and
executing a posteriori probability (APP) decoding in an a posteriori probability method with respect to the recursive systematic coded sequence.

9. The method according to claim 8, wherein a relation equation “N=c·M, where c>1” is satisfied between the interleaver length N and code length M.

10. The method according to claim 8, further comprising:
converting the recording data sequence to a run length limited code (RLL); and
executing the interleaving in the predetermined interleaver length with respect to an RLL sequence.

11. The method according to claim 8, further comprising:
executing the RSC coding to code the interleaved RLL sequence to a recursive systematic coded sequence to which predetermined redundant bits are added using a predetermined code length as a unit.

12. The method according to claim 8, further comprising:
executing puncture in a thinning rate to secure a predetermined error rate with respect to the recursive systematic coded sequence.
